(19) United States
(12) Patent Application Publication
(10) Pub. No.: US 2026/0236753 A1
(43) Pub. Date: Aug. 13, 2026

(54) NON LINEARITY IMPLEMENTATIONS USING LUTS

(71) Applicant: XILINX, INC., San Jose, CA (US)

(72) Inventors: Krishnakumar NAIR, San Jose, CA (US); Ashish SIRASAO, San Jose, CA (US); Rajeev PATWARI, San Jose, CA (US); Steven Karl REINHARDT, Bellevue, WA (US); Satyaprakash PAREEK, San Jose, CA (US)

(21) Appl. No.: 19/051,723

(22) Filed: Feb. 12, 2025

(51) Int. Cl. G06N 3/048

(52) U.S. Cl. CPC G06N 3/048

(57) ABSTRACT

Embodiments herein describe using LUTs to map an input value to a non-linear output value as part of a non-linear activation function in a machine learning (ML) model. In one embodiment, two (or more) LUTs are used to approximate a non-linear activation function (e.g., GELU, SILU, Sigmoid, Tanh, etc.). The first LUT can define input ranges (e.g., -1 to 0, 0 to 1, 1 to 2, etc.) which have unequal numbers of splines, which can be determined using derivative analysis on the non-linear function. The first LUT can store pointers, corresponding to the splines, that point to entries in a second LUT. The entries in the second LUT contain coefficients to that can be used to calculate the non-linear output value.

### TECHNICAL FIELD

The embodiments presented herein relate to implementing non-linear activation functions (such as GELU) using look-up tables (LUTs).

### BACKGROUND

Many machine learning (ML) models (e.g., neural network models) use non-linear activation functions (Gaussian Error Linear Unit (GELU), Sigmoid Linear Unit (SiLU), Sigmoid, hyperbolic tangent function (Tanh), etc.) to introduce non linearity. To achieve a desired accuracy, floating point implementation is often used for these non-linearities both in training as well as inference flows such as Quantize and De-Quantize (QDQ). Typical hardware fixed function implementations of non-linear activation functions use LUTs to implement. While using LUTs is efficient for integer arithmetic, floating point LUTs encounter problems such as large number of entries, asymmetric range, accuracy limitations, and power inefficiency.

### SUMMARY

One embodiment described herein is a computing system that includes memory storing a first look-up table (LUT) and a second LUT for performing a non-linear activation function in a machine learning (ML) model. The first LUT is divided into a plurality of input ranges where each of the plurality of input ranges includes at least one spline, and where each of the splines corresponds to a pointer stored in the first LUT. Further, the second LUT includes entries pointed to by the pointers in the first LUT where the entries store coefficients for calculating a non-linear output value.

One embodiment described herein is a method includes receiving an input value at a non-linear activation function in a ML model, indexing into a first LUT using the input value to identify a pointer where the first LUT is divided into a plurality of input ranges where each of the plurality of input ranges comprises at least one spline and where each of the splines corresponds to a pointer stored in the first LUT. The method also includes indexing into a second LUT using the pointer to identify coefficients where the second LUT comprises entries pointed to by the pointers in the first LUT and determining, using the coefficients and the input value, a non-linear output of the non-linear activation function.

One embodiment described herein is a method that includes defining a plurality of input ranges for dividing a first LUT, defining a number of splines for each of the plurality of input ranges using derivative analysis, generating a first LUT containing pointers corresponding to the number of splines for each of the plurality of input ranges, and generating a second LUT containing entries storing coefficients for determining an output value for each of the splines when performing a non-linear activation function for a ML model.

### BRIEF DESCRIPTION OF DRAWINGS

FIG. 1 is a chart of the GELU activation function, according to one embodiment herein.

FIG. 2 illustrates a system for implementing a non-linear activation function using LUTs, according to one embodiment herein.

FIG. 3 is flowchart for populating LUTs for implementing a non-linear activation function, according to one embodiment herein.

FIG. 4 illustrates LUTs for implementing a non-linear activation function, according to one embodiment herein.

FIG. 5 is a flowchart for adjusting LUTs to satisfy an accuracy threshold, according to one embodiment herein.

FIG. 6A illustrates adding a spline to satisfy an accuracy threshold, according to one embodiment herein.

FIG. 6B illustrates changing to high order polynomial coefficients to satisfy an accuracy threshold, according to one embodiment herein.

### DETAILED DESCRIPTION

Embodiments herein describe using LUTs with non-uniform ranges to perform piece wise linear (PWL) functions to map an input value to a non-linear output value. In one embodiment, two (or more) LUTs are used to perform the PWL function to approximate a non-linear activation function (e.g., GELU, SILU, Sigmoid, Tanh, etc.) The first LUT can define input ranges (e.g., -1 to 0, 0 to 1, 1 to 2, etc.) which have unequal numbers of splines. For example, the non-linear activation function may not change much in the range of -1 to 0, so few splines are assigned to this range, but may change significantly from 0 to 1 so more splines are assigned to this range. In one embodiment, the number of splines is determined by performing first order or second order derivative analysis on the non-linear function.

In one embodiment, each of the splines can store a pointer to an entry in a second LUT which stores the coefficients for performing PWL to identify the non-linear output value. For example, the PWL function may be defined by the function y=mx+c where the entry in the second LUT stores the values of m and c which can be used (along with the input value x) to calculate the output y.

Because the LUTs store the coefficients used to approximate the non-linear function, the system can ensure the LUTs satisfy an accuracy threshold (e.g., a desired threshold of Layer 2 normalization (L2 Norm)). In one embodiment, the system can check each of the entries in the second LUT to determine whether the coefficients, when used in the PWL function, output a result that satisfies the accuracy threshold. If not, the system can add another spline to the input range, or increase the number of polynomials of the coefficients in the entry. In one embodiment, the system can perform both strategies until the entry satisfies the accuracy threshold and then select which optimization to accept (e.g., adding additional splines or increasing the polynomials of the coefficients) depending on an optimization criteria (e.g., reducing memory usage or reduce power consumption).

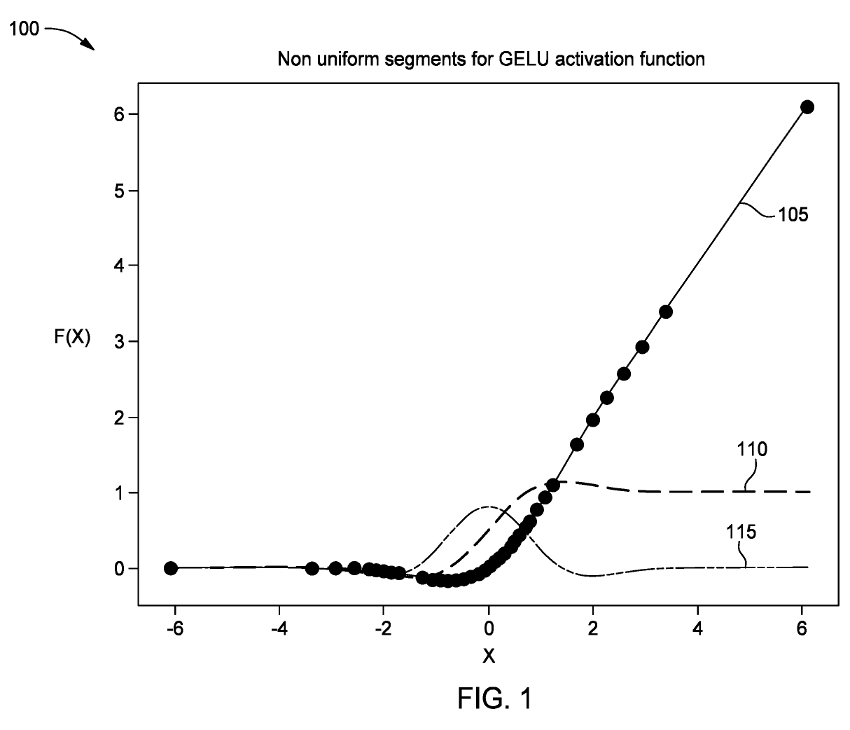

FIG. 1 is a chart 100 of the GELU activation function, according to one embodiment herein. The plot 105 illustrates the GELU activation function which takes input values (the X axis) and converts them to output values (the Y axis). In addition, the chart 100 includes the plot 110 that illustrates the first order derivative of the GELU function shown by plot 105. The chart 100 also includes the plot 115 that illustrates the second order derivative of the GELU function shown by plot 105.

The derivatives in plots 110 and 115 illustrate where the GELU function in plot 105 has the most change. As shown by the plots 110 and 115, the GELU function does not change much from the range -6 to -3 on the x axis, changes the most in the input range of -3 to 1 and then changes little from 1 to 6.

As discussed in more detail below, the derivatives of a non-linear function can be used to divide the function into different segments or splines. The regions of the plot 105 that have the most change can be assigned more of the segments (represented as the dots in FIG. 1). That is, more segments are assigned to the input range of -3 to 1 than to the ranges -6 to -3 and 1 to 6. These assigned segments can then be used to generate the LUTs that approximate the non-linear activation function. Because the density of the segments is concentrated where the GELU function changes the most, this improves accuracy as well as potentially reducing the amount memory that is used, relative to a strategy where the segments are spaced equally along the GELU function.

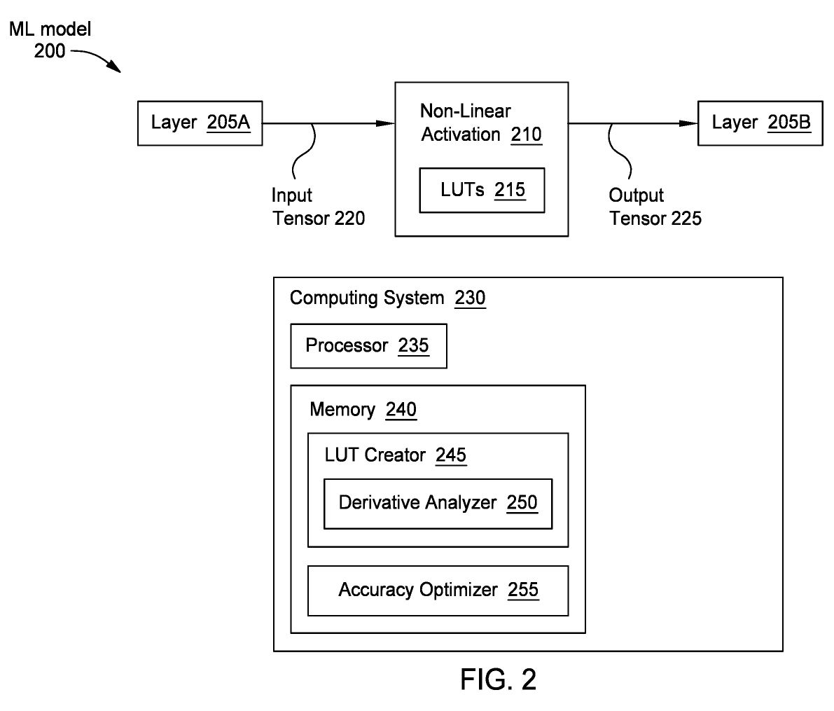

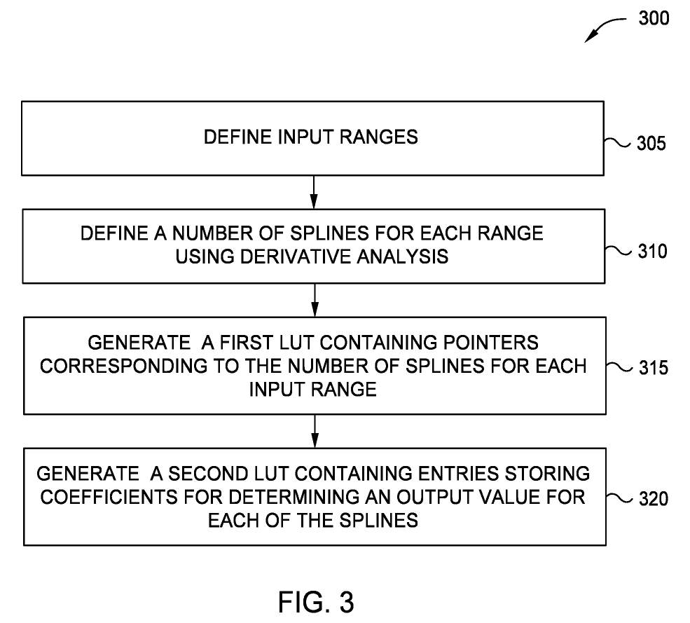

FIG. 2 illustrates a system for implementing a non-linear activation function using LUTs, according to one embodiment herein. The system includes a ML model 200 which includes a layer 205A that generates an input tensor 220 for a non-linear activation 210. In this example, the non-linear activation 210 can be any non-linear activation function (e.g., GELU, SILU, Sigmoid, Tanh, etc.) which is approximated using LUTs 215). That is, as discussed in more detail in FIGS. 3-5, the LUTs 215 can used stored coefficients to perform PWL functions that approximate the non-linear function.

The output tensor 225 includes the non-linear output values generated by performing the look ups into the LUTs 215, which is passed to a second layer 205B in the ML model 200. In this manner, a non-linear activation function can be performed on the input tensor 220 to generate the output tensor 225. Non-linear activation functions are used in ML models to introduce non-linearity, allowing the network to learn and model complex patterns in data by enabling it to create intricate relationships between inputs and outputs, which would be impossible with a purely linear model. Non-linear activation functions give the network the ability to learn beyond simple straight lines and capture more nuanced features in data.

FIG. 2 also includes a computing system 230 which includes a processor 235 which represents any number of processing elements that can include any number of processing cores. The computing system 230 also includes memory 240 which can include volatile memory elements, non-volatile memory elements, and combinations thereof.

The memory 240 includes a LUT creator 245 for generating the LUTs 215 used to approximate the non-linear activation 210. As discussed in FIG. 3, the LUT creator 245 (e.g., a software application) can use a derivative analyzer 250 (e.g., a software application or module) to identify the regions where the non-linear activation 210 changes (according to the first or second order derivatives) and assign splines and segments accordingly. As shown in FIG. 1, the derivative analyzer 250 can assign more segments or splines where the non-linear activation 210 changes the most while assigning fewer segments or splines where the activation 210 does not change much.

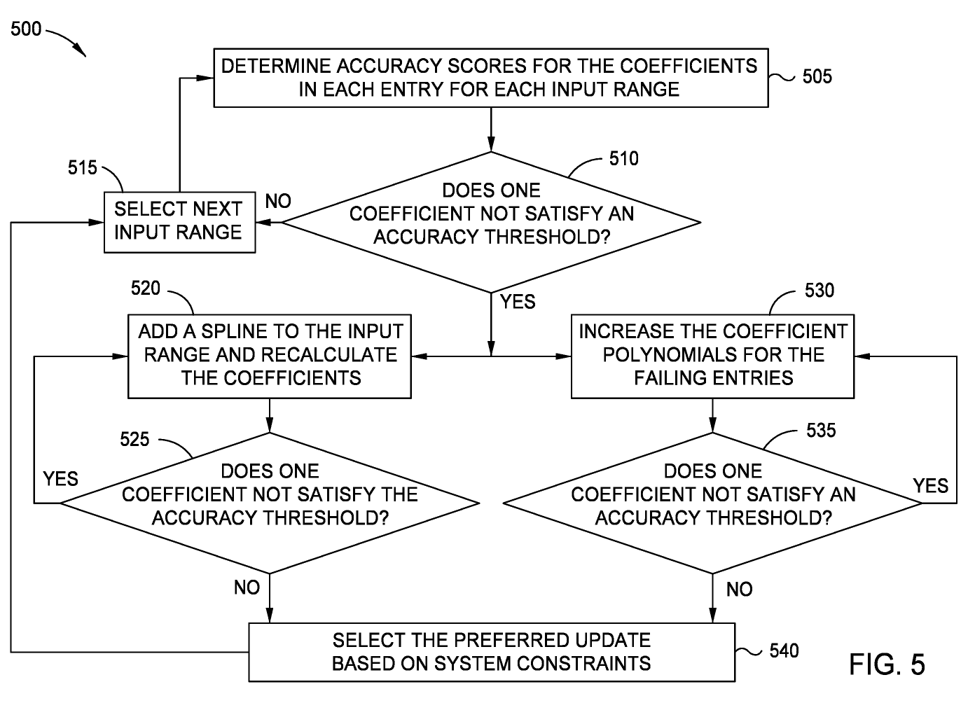

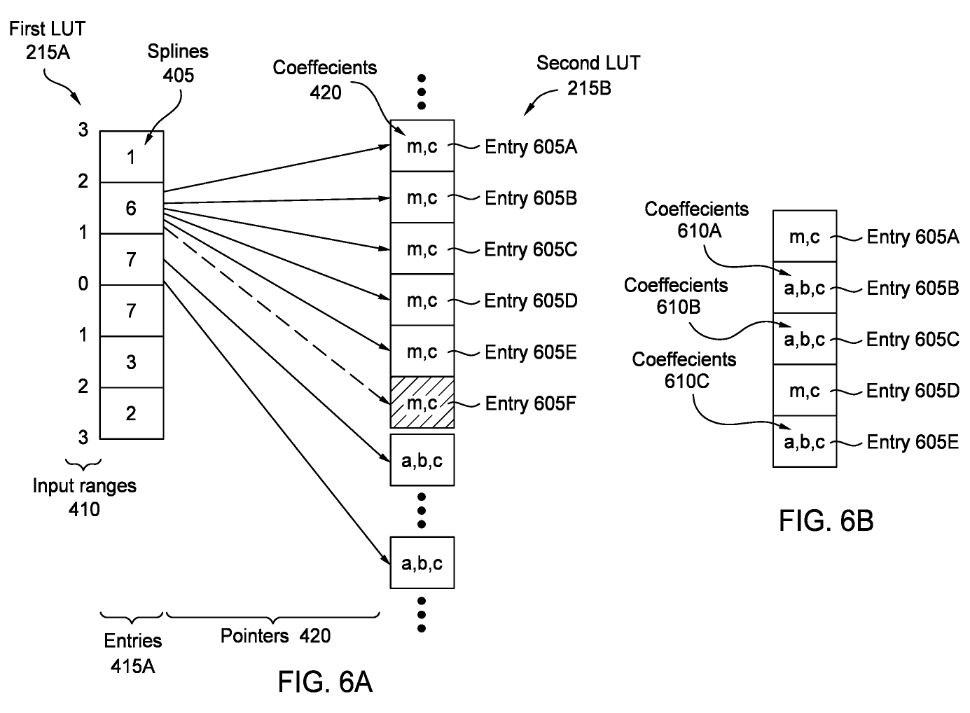

The memory 240 also includes an accuracy optimizer 255 (e.g., a software application) that adjusts and changes the LUTs 215 to ensure they sufficiently approximate the non-linear activation 210. If not, the accuracy optimizer 255 can increase the number of segments or splines in an input range, or increase the number of coefficients stored in the entries. This is discussed in more detail in FIGS. 5-6.

FIG. 3 is flowchart of a method 300 for populating LUTs for implementing a non-linear activation function, according to one embodiment herein. At block 305, the LUT creator (e.g., the LUT creator 245 in FIG. 2) defines input ranges for a non-linear activation function. Using FIG. 1 as an example, the input ranges (e.g., the X axis) may be divided into -6 to -5, -5 to -4, -4 to -3, and so forth. In one embodiment, the input ranges may be equal sizes, although this is not a requirement.

At block 310, the derivative analyzer (e.g., the derivative analyzer 250 in FIG. 2) defines a number of splines (or segments) for each of the input ranges determined at block 305 using derivative analysis. For example, the derivative analyzer can determine the first or second order derivatives of the non-linear activation function to determine the input ranges where the non-linear activation changes the most. Referring again to FIG. 1, the derivative analyzer can assign more splines or segments to the input regions where the GELU function changes the most (e.g., the input ranges from -3 to 1).

The embodiments herein can be used with any suitable derivate analysis algorithm. As a non-limiting example, the Ramer-Douglas-Peucker Algorithm can be used to convert an equal spacing of segments of the GELU function into the unequal spacing of segments/splines shown in FIG. 1. Further, performing derivative analysis can reduce the number of segments or splines. For example, the derivative analysis can take into account L2 norm to reduce the number of segments/splines used to represent the non-linear activation function.

At block 310, the input ranges are assigned one or more segments or splines where some input ranges have more segments/splines assigned to them than other input ranges. In FIG. 1, the input range -6 to -5 may have only a few splines while the input range -1 to 0 may have ten, or a hundred, times more segments.

At block 315, the LUT creator generates a first LUT containing pointers corresponding to the number of splines for each input range. Stated differently, the LUT creator can assign entries in the first LUT to each input range for the number of splines or segments in that input range. For example, if the input range -6 to -5 was assigned two segments/splines at block 310, then the LUT creator assigns two entries for those two segments in the first LUT. In contrast, if the input range -1 to 0 was assigned 12 segments at block 310, then the LUT creator assigns 12 entries for those 12 segments in the first LUT.

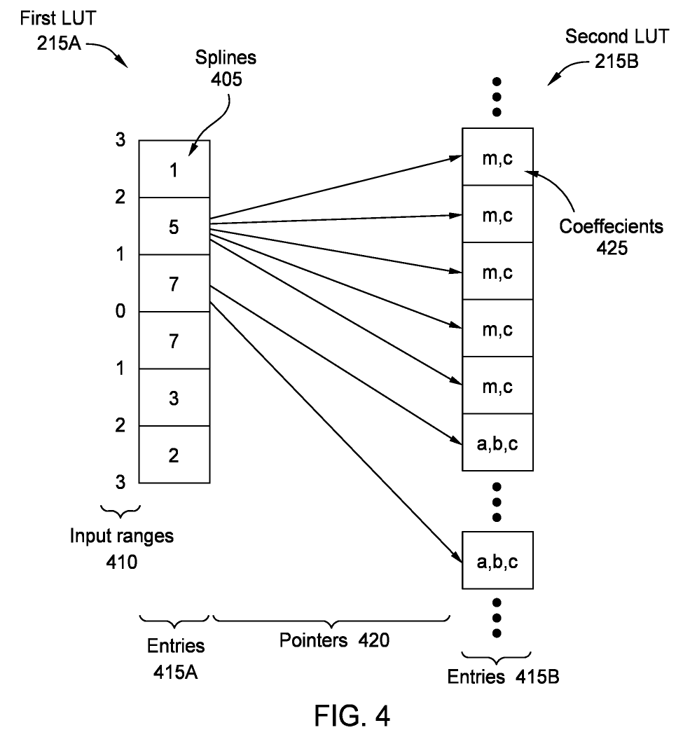

FIG. 4 illustrates LUTs for implementing a non-linear activation function, according to one embodiment herein. Specifically, FIG. 4 illustrates a first LUT 215A, which is one example of a LUT that is created at block 315 of the method 300. The first LUT 215A is indexed by equally spaced input ranges 410 (i.e., 3 to 2, 2 to 1, 1 to 0, etc.) but the number of splines 405 assigned to each of those input ranges 410 can be different. That is, the input range 3 to 2 only has one spline 405 while the input range 2 to 1 has 5 splines 405 and the input range 1 to 0 has 7 splines 405. Each of the splines 405 can be assigned a corresponding entry in the first LUT 215A which stores a pointer 420. For example, the input range 2 to 1 has five entries in the first LUT 215A with five pointers 420.

The pointers 420 point to a respective entry in a second LUT 215B. For example, the five splines 405 in the input range 2 to 1 point to five entries in the second LUT 215B while the seven splines 405 in the input range 1 to 0 point to seven entries in the second LUT 215B.

Returning to FIG. 3, at block 320 the LUT creator generates a second LUT (e.g., the LUT 215B in FIG. 4) containing entries storing coefficients for determining an output value for each of the splines The types of coefficients can depend on the type of PWL being used to approximate the non-linear activation function. For example, if the PWL function is y=mx+c, then each entry can store a value for m and c for that segment or spline. That is, each entry can store a different or custom value of m and c for that particular x value.

However, the entries in the second LUT can store coefficients for different functions. For example, the non-linear activation can instead be approximated using the function y=ax²+bx+c. In that case, the entries can store the values of the coefficients a, b, and c. Or the non-linear activation can instead be approximated using the function y=ax³+bx²+cx+d. In that case, the entries can store the values of the coefficients a, b, c, and d. Generally, as higher order polynomials are used, the accuracy of the PWL function to approximate the non-linear function is increased. However, this is a trade off since it uses more memory to store the coefficients (since more coefficients are used). Moreover, the number of operations used to calculate the non-linear output value increases as higher order polynomials are used. For example, when using y=mx+c, the hardware can calculate the output y value by performing one multiply (e.g., multiplying the coefficient m stored in the second LUT with the input value x) and one add (e.g., adding the result of the multiplication with the coefficient c stored in the second LUT). However, when using y=ax²+bx+c, the hardware calculates the output y value by performing three multiplies and two adds. Thus, there is a tradeoff between accuracy and the amount of memory and compute processing. This tradeoff will be discussed in more detail in FIG. 5 when adjusting the LUTs to satisfy an accuracy threshold.

As shown in FIG. 4, the second LUT 215B has multiple entries 415B that store coefficients 425 for the splines 405 in the first LUT 315A. Put differently, the entries 415A in the first LUT 215A store pointers 420 to the coefficients 425 for each of the splines 405. As shown, the types of coefficients 425 stored in the entries 415B in the second LUT 215B can vary. For example, some of the entries 415B store coefficients that are used in the linear approximation y=mx+c. However, other entries 415B store coefficients that are used in the quadratic approximation y=ax²+bx+c. As such, the LUT architecture shown in FIG. 4 provides the ability for each entry 415B to store coefficients for a different piece wise approximation. Advantageously, this gives the LUT approximation technique greater flexibility to select which of the entries should include coefficients for higher order polynomials. This can reduce the amount of memory used to store the second LUT 215B as well as enable the hardware to perform less compute intensive approximations, relative to a system where every entry 415B stores coefficients for a higher order polynomial when some entries may not need to use the higher order polynomial to satisfy an accuracy threshold.

In one embodiment, when generating the second LUT, the LUT creator uses the coefficients for the least compute intensive approximation (e.g., y=mx+c). For example, when the second LUT is first created, every entry 415B can include m and c values. That is, the LUT creator can use the ranges of the splines 405 to generate m and c values for each of the splines 405 and then store these m and c values in the corresponding entries 415B. However, as discussed in FIG. 5, the accuracy optimizer may change these values to coefficients for a high order polynomial (e.g., a, b, and c) in order to satisfy the accuracy threshold.

In one embodiment, the table creation described in method 300 is a one-time operation based on the non linearity function as well as the accuracy requirement. Table creation can be done prior to compile time and stored in memory.

FIG. 5 is a flowchart of a method 500 for adjusting LUTs to satisfy an accuracy threshold, according to one embodiment herein. The method 500 assumes that method 300 has already been performed where multiple LUTs have been generated in order to approximate a non-linear activation function.

At block 505, the accuracy optimizer (e.g., the accuracy optimizer 255) determines accuracy scores using the coefficients in each entry in an input range. That is, in this example, the accuracy optimizer identifies the entries in the second LUT corresponding to each spline in the input range. For example, if the input range 2 to 1 has 5 splines, the accuracy optimizer can calculate the L2 norm for each of the coefficients. In this scenario, the splines in each input range are considered as a batch, although the coefficients for each individual spline can be checked to determine whether they satisfy the accuracy threshold (e.g., a sufficient L2 norm score). This is helpful when considering whether to add additional splines/segments to a particular input range (e.g., increasing the number of splines from 5 to 6 for the input range 2 to 1).

However, in other embodiments the splines can be optimized individually, without considering the splines in a particular input range. In that example, the accuracy optimizer may switch to using higher order polynomials for the coefficients for a particular spline.

That being said, the embodiments below discuss an optimization process where the accuracy optimizer considers both increasing the number of splines in an input range and using higher order polynomials when coefficients for a spline do not satisfy the desired accuracy threshold.

At block 510, the accuracy optimizer determines whether one coefficient for an input range does not satisfy an accuracy threshold (e.g., a desired value of L2 norm).

If the coefficients for each spline in the input range do satisfy the accuracy threshold, the method 500 proceeds to block 515 where the accuracy optimizer selects the next input range (e.g., the input range 1 to 0) and then the method 500 repeats at block 505.

However, if one of the coefficients for a spline in the input range does not satisfy the accuracy threshold, the method 500 instead performs blocks 520 and 530. That is, method 500 includes two parallel paths starting at blocks 520 and 530 that can be performed at the same time or sequentially.

At block 520, the accuracy optimizer adds a spline to the input range and recalculates the coefficients for each spline in the input range. For example, instead of having 5 splines, the accuracy optimizer can add a sixth spline to the input range 2 to 1. Since this changes the way the splines subdivide the input range, the accuracy optimizer recalculates the coefficients for each of the splines. Put differently, adding another spline can change the values for the coefficients of each of the splines in the input range.

In one embodiment, the coefficients have the same type of polynomials when the spline is added. For example, if the coefficients store values of m and c for calculating y=mx+c, they continue to store these types of coefficient, although the values for m and c may change. As another example, some of the 5 splines have one type of coefficients (e.g., a, b, c for calculating y=ax²+bx+c) while others have values for m and c. When the new spline is added, the old splines may have the same type of coefficients albeit that the accuracy optimizer calculates new values for those coefficients. In one embodiment, when adding a spline at block 520, the accuracy optimizer may use coefficients of the lowest order polynomial (e.g., the 6^{th} spline can point to values for m and c). For example, the lowest order polynomials may be the default when adding splines.

FIG. 6A illustrates adding a spline to satisfy an accuracy threshold, according to one embodiment herein. That is, FIG. 6A illustrates one example of adding a spline to an input range when coefficients for one of the splines in that input range do not satisfy the accuracy threshold. In this case, the accuracy optimizer has increased the number of splines for the input range 2 to 1 from 5 (as illustrated in FIG. 4) to 6. To do so, the accuracy optimizer adds another pointer 420 to the first LUT 215A.

The accuracy optimizer adds a new entry in the second LUT 215B which is pointed to by the pointer 420 for the sixth spline in the first LUT 215A. The accuracy optimizer calculates values for m and c which are stored in the new entry in the second LUT 215B. Moreover, because adding a spline causes the splines to change how the input range is divided, the accuracy optimizer also recalculates the m and c values for the other 5 splines in the input range.

At block 525, the accuracy optimizer determines whether one of the coefficients does not satisfy the accuracy threshold. Put differently, the accuracy optimizer recalculates the accuracy score for the coefficients given these values may have changed when a new spline was added at block 520.

If the coefficients for a least one of the splines still does not satisfy the accuracy threshold, the method 500 returns to block 520 where the accuracy optimizer adds another spline in the input range and recalculates the coefficients for the splines in the input range. That is, blocks 520 and 525 can repeat where new splines are added to an input range until the coefficients for each of the splines in that range satisfy the accuracy threshold.

When coefficients for each of the splines in the input range satisfy the accuracy threshold, the method 500 proceeds to block 540, which is described below.

Returning to block 530, the accuracy optimizer increases the coefficient polynomials for the failing entries in the second LUT. For example, at block 510 the accuracy optimizer can identify which of the entries in the second LUT for splines in a particular input range have coefficients that do not satisfy the accuracy threshold. At block 530, the accuracy optimizer can increase the number of coefficients to use a higher order polynomial to calculate the output values.

FIG. 6B illustrates changing to high order polynomial coefficients to satisfy an accuracy threshold, according to one embodiment herein. FIG. 6B is one example of performing block 530 where the accuracy optimizer increases the polynomials used to calculate the non-linear output value.

FIG. 6B illustrates six entries 605A-E in a second LUT that correspond to splines in the selected input range. It is assumed that each of the entries 605 used to store values for m and c in order to approximate the non-linear output using the equation y=mx+c. However, when performing blocks 505 and 510 in FIG. 5, the accuracy optimizer determined that coefficients 610A, B, and C in the entries 605B, C, and E did not satisfy the accuracy threshold.

In response, the accuracy optimizer switches the types of coefficients in entries 605B, C, and E from m and c to a, b, and c so that the more accurate higher order polynomial y=ax2+bx+c can be used to calculate the non-linear output value, which may better approximate the actual non-linear function. In this example, the accuracy optimizer can selectively update the coefficients that do not satisfy the accuracy threshold while leaving the entries 605 with coefficients to do satisfy the accuracy threshold unchanged. This can save memory and compute resources since less data is stored in the second LUT and less operations are performed to calculate the non-linear values (e.g., only two multiples and one add rather than three multiplies and two adds).

Returning to the method 500, at block 535 the accuracy optimizer determines whether the coefficients for one spline do not satisfy the accuracy threshold. That is, the accuracy optimizer may recalculate the accuracy score for the entries that had their coefficients increased. The accuracy optimizer can then determine whether those updated accuracy scores satisfy the accuracy threshold.

One of the entries 605B, C, and E in FIG. 6 which now store coefficients for a higher order polynomial may still not satisfy the accuracy threshold (e.g., do not have a satisfactory L2 norm). In that case, the method 500 can return to block 530 where the accuracy optimizer again increase the coefficients polynomials for the failing entries. Using FIG. 6B as an example, the coefficients 610A and 610B may now have accuracy scores that satisfy the threshold, but the coefficients 610C may not. In response, the accuracy optimizer can increase the coefficients 610C to include a, b, c, and d values that can be used in the polynomial y=ax³+bx²+cx+d. In this manner, the method 500 can continue to increase the coefficients for the failing entries in the second LUT until they satisfy the accuracy threshold, and then proceed to block 540.

At block 540, the accuracy optimizer can evaluate the optimizations performed at blocks 520/525 and blocks 530/535 to determine which optimization to accept. For example, the accuracy optimizer can use optimization criteria (e.g., reducing memory usage or reducing power consumption) to determine which optimization to accept. For example, performing blocks 520/525 may result in adding four more splines to the input range (and the accompanying overhead) while performing blocks 530/535 results in having to increasing the coefficients for only two entries in the second LUT. Although increasing the coefficients may mean more complex operations are performed, this approach may save memory relative to adding four splines. The accuracy optimizer can use the optimization criteria to select which optimization to use to update the first and second LUTs. In this case, the accuracy optimizer may select to increase the coefficients in the two entries, while leaving the number of splines in the input range unchanged. However, in another example, the accuracy optimizer may increase the number of splines, and continue to use the same type(s) of coefficients in the second LUT. In yet another embodiment, the accuracy optimizer may perform a mix of the optimizations such as increasing the splines in the input range as well as increasing the coefficients to support a high order polynomial.

After performing block 540, the method 500 proceeds to block 515 where a new input range is selected and the method 500 repeats. After iterating through each input range, the accuracy optimizer will have ensured that the coefficients for each entry in the second LUT satisfies the accuracy threshold.

The first and second LUTs can then be stored in memory in the computing system to be used to approximate a non-linear function. That is, when a ML model sends an input vector to an non-linear activation function, the function can use the values in the input vector to index into the first LUT to identify a pointer to the second LUT. The coefficients stored in the corresponding entry in the second LUT (as well as the input value in the input vector) can be used to calculate the non-linear approximation using one of the equations discussed above (e.g., y=mx+c, y=ax²+bx+c, etc.).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A computing system, comprising:
memory storing:
a first look-up table (LUT) and a second LUT for performing a non-linear activation function in a machine learning (ML) model,
wherein the first LUT is divided into a plurality of input ranges, wherein each of the plurality of input ranges comprises at least one spline, wherein each of the splines corresponds to a pointer stored in the first LUT, and
wherein the second LUT comprises entries pointed to by the pointers in the first LUT, wherein the entries store coefficients for calculating a non-linear output value.

2. The computing system of claim 1, wherein a first range of the plurality of input ranges corresponds to a first number of splines and a first number of pointers, wherein a second range of the plurality of input ranges corresponds to a second number of splines and a second number of pointers, different from the first number of splines and the first number of pointers.

3. The computing system of claim 2, wherein the first and second number of splines are determined by performing derivative analysis on a non-linear function corresponding to the non-linear activation function, wherein the first and second LUTs approximate the non-linear function.

4. The computing system of claim 3, wherein the non-linear function comprises one of: GELU, SILU, Sigmoid, Tanh.

5. The computing system of claim 1, wherein first coefficients stored in a first entry in the second LUT correspond to a lower order polynomial while second coefficients stored in a second entry in the second LUT correspond to a higher order polynomial.

6. The computing system of claim 5, wherein the first and second entries in the second LUT correspond to two splines in a same input range of the plurality of input ranges.

7. The computing system of claim 6, wherein the plurality of input ranges are equal.

8. A method comprising:
receiving an input value at a non-linear activation function in a ML model;
indexing into a first LUT using the input value to identify a pointer, wherein the first LUT is divided into a plurality of input ranges, wherein each of the plurality of input ranges comprises at least one spline, wherein each of the splines corresponds to a pointer stored in the first LUT;
indexing into a second LUT using the pointer to identify coefficients, wherein the second LUT comprises entries pointed to by the pointers in the first LUT; and
determining, using the coefficients and the input value, a non-linear output of the non-linear activation function.

9. The method of claim 8, wherein a first range of the plurality of input ranges corresponds to a first number of splines and a first number of pointers, wherein a second range of the plurality of input ranges corresponds to a second number of splines and a second number of pointers, different from the first number of splines and the first number of pointers.

10. The method of claim 9, further comprising, before receiving the input value:
performing derivative analysis on a non-linear function corresponding to the non-linear activation function to determine the first and second number of splines.

11. The method of claim 10, wherein the non-linear function comprises one of: GELU, SILU, Sigmoid, Tanh.

12. The method of claim 8, wherein first coefficients stored in a first entry in the second LUT correspond to a lower order polynomial while second coefficients stored in a second entry in the second LUT correspond to a higher order polynomial.

13. The method of claim 12, wherein the first and second entries in the second LUT correspond to two splines in a same input range of the plurality of input ranges.

14. The method of claim 13, wherein the plurality of input ranges are equal.

15. A method comprising:
defining a plurality of input ranges for dividing a first LUT;
defining a number of splines for each of the plurality of input ranges using derivative analysis;
generating a first LUT containing pointers corresponding to the number of splines for each of the plurality of input ranges; and
generating a second LUT containing entries storing coefficients for determining an output value for each of the splines when performing a non-linear activation function for a ML model.

16. The method of claim 15, further comprising:
determining accuracy scores for the coefficients in a set of entries in the second LUT corresponding to a first range of the plurality of input ranges; and
determining that at least one entry of the set of entries has an accuracy score that does not satisfy an accuracy threshold.

17. The method of claim 16, further comprising:
adding a new spline to the first range;
adding a new pointer for the new spline in the first LUT;
adding an entry in the second LUT that is pointed to by the new pointer;
calculating new coefficients for first range and storing the new coefficients in the second LUT; and
calculating new accuracy scores for the new coefficients.

18. The method of claim 17, further comprising:
determining, using the new accuracy scores, that at least one entry of the set of entries has an accuracy score that does not satisfy the accuracy threshold; and
adding another new spline to the first range.

19. The method of claim 16, further comprising:
changing to coefficients for a higher order polynomial for each entry in the set of entries that had an accuracy score that did not satisfy the accuracy threshold, wherein the coefficients for each entry in the set of entries that has an accuracy score that does satisfy the accuracy threshold are unchanged.

20. The method of claim 19, further comprising:
determining new accuracy scores for the coefficients for the higher order polynomial;
determining that at least one entry of the set of entries has a new accuracy score that does not satisfy the accuracy threshold; and
changing to coefficients for a higher order polynomial for the at least one entry that has an accuracy score that does not satisfy the accuracy threshold.
